(19) United States
(12) Patent Application Publication
(10) Pub. No.: US 2017/0361433 A1
(43) Pub. Date: Dec. 21, 2017

(54) RATCHET WRENCH WITH POSITIONING STRUCTURE

(71) Applicant: YIH CHENG FACTORY CO., LTD., Nantuo (TW)

(72) Inventor: Chih-Hung CHIEN, Nantuo (TW)

(21) Appl. No.: 15/185,049

(22) Filed: Jun. 17, 2016

(51) Int. Cl. B25B 23/00; B25B 13/48; B25B 13/46

(52) U.S. Cl. CPC B25B 23/0028; B25B 13/461; B25B 13/481

(57) ABSTRACT

A ratchet wrench with a positioning structure includes a drive bar, a rotary head, and a locking button. The drive bar includes a fork arm, a fork opening formed at the fork arm, an axial hole communicating with the fork opening, and a radial hole communicating with the axial hole. The rotary head is pivotally connected to two ends of the fork arm. The rotary head includes a round housing, a plurality of positioning recesses disposed on the round housing, and a pivot axis located at the rotary head and passing through two ends of the fork arm. The pivot axis is parallel to the radial hole. The locking button includes a locking rod disposed in the radial hole and a latch bar disposed in the axial hole. The locking rod is transversely movable in association with movement of the latch bar.

### TECHNICAL FIELD

The present invention relates to a ratchet wrench and, in particular, to a ratchet wrench with a positioning structure, which is freely rotatable to certain angles.

### BACKGROUND

The ratchet wrench is a common hand tool for tightening operations. The ratchet wrench can be used flexibly and can move back and forth freely to tighten or loosen screw blots, screws, or the likes, so it replaces a traditional wrench in many places.

The ratchet wrench includes a head portion, a bar extending outwardly from the head portion, and a drive head disposed on the head portion. The drive head is drivingly associated with objects, e.g. screw nuts and screw bolts, by means of a variety of sleeves in different sizes. A user simply needs to hold the bar to swing it, and the objects can be loosened or tightened. However, the conventional ratchet wrench is often limited by a dead corner or a tiny space, and thereby the drive head of the ratchet wrench cannot fasten the objects smoothly. In solution, there is a ratchet wrench with a drive head rotatable with respect to the bar. However, the ratchet wrench with the rotatable drive head has a complicated structure for fixing the drive head, and its inconvenient operations cannot meet the market's expectations.

Accordingly, the inventor made various studies to solve the above-mentioned problems, on the basis of which the present invention is accomplished.

### SUMMARY

It is an object of the present invention to provide a ratchet wrench with a positioning structure, whereby a rotary head can be fastened or released quickly by transversely pushing a lock button to move.

Accordingly, the present invention provides a ratchet wrench with a positioning structure, comprising a drive bar, a rotary head and a locking button. The drive bar includes a fork arm, a fork opening formed at the fork arm, an axial hole communicating with the fork opening, and a radial hole communicating with the axial hole. The rotary head is pivotally connected to two ends of the fork arm, the rotary head includes a round housing, a ratchet apparatus disposed inside the round housing, a plurality of positioning recesses disposed on the round housing, and a pivot axis located at the rotary head and passing through the two ends of the fork arm, wherein the pivot axis is parallel to the radial hole. The locking button includes a locking rod disposed in the radial hole and a latch bar disposed in the axial hole. The locking rod is transversely movable in association with movement of the latch bar, and the latch bar is engaged with or disengaged from any of the positioning recesses.

The present invention further has the following merits. By pushing backwards and forwards or moving reciprocately the locking button, the rotary head can be fastened or released quickly. Therefore, the present invention has the advantages of a simple structure and easy operations. In addition, a retaining structure of the present invention serves to enhance the stability and reliability of the locking button in a locked position or a released position.

### BRIEF DESCRIPTION OF THE DRAWINGS

The disclosure will become more fully understood from the detailed description, and the drawings given herein below is for illustration only, and thus does not limit the disclosure, wherein:

FIG. 1 is a perspective view illustrating a ratchet wrench with a positioning structure according to the present invention;

FIG. 2 is a partial cross-sectional view illustrating the ratchet wrench with the positioning structure according to the present invention;

FIG. 3 is another perspective view illustrating the ratchet wrench with the positioning structure according to the present invention;

FIG. 4 is a partial cross-sectional view of FIG. 3;

FIG. 5 is still another perspective view illustrating the ratchet wrench with the positioning structure according to the present invention; and

FIG. 6 is a partial cross-sectional view of FIG. 5.

### DETAILED DESCRIPTION

Detailed descriptions and technical contents of the present invention are illustrated below in conjunction with the accompany drawings. However, it is to be understood that the descriptions and the accompany drawings disclosed herein are merely illustrative and exemplary and not intended to limit the scope of the present invention.

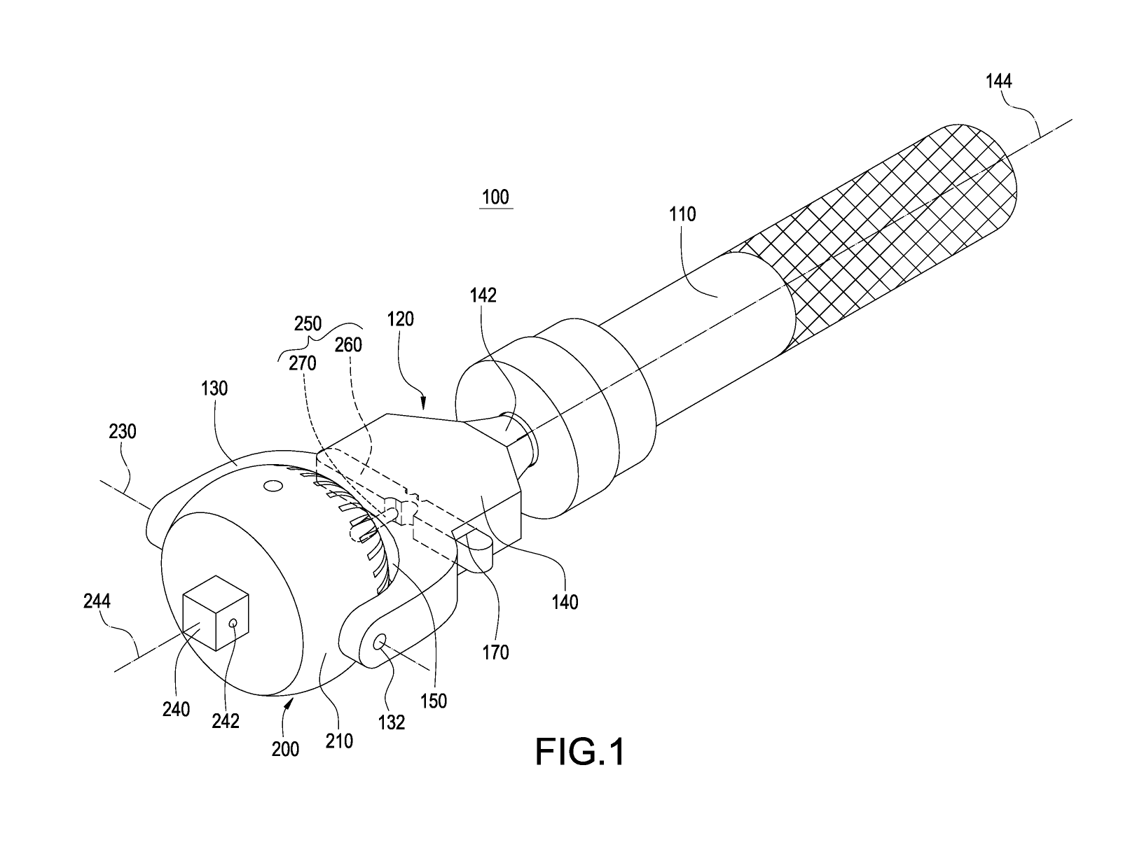

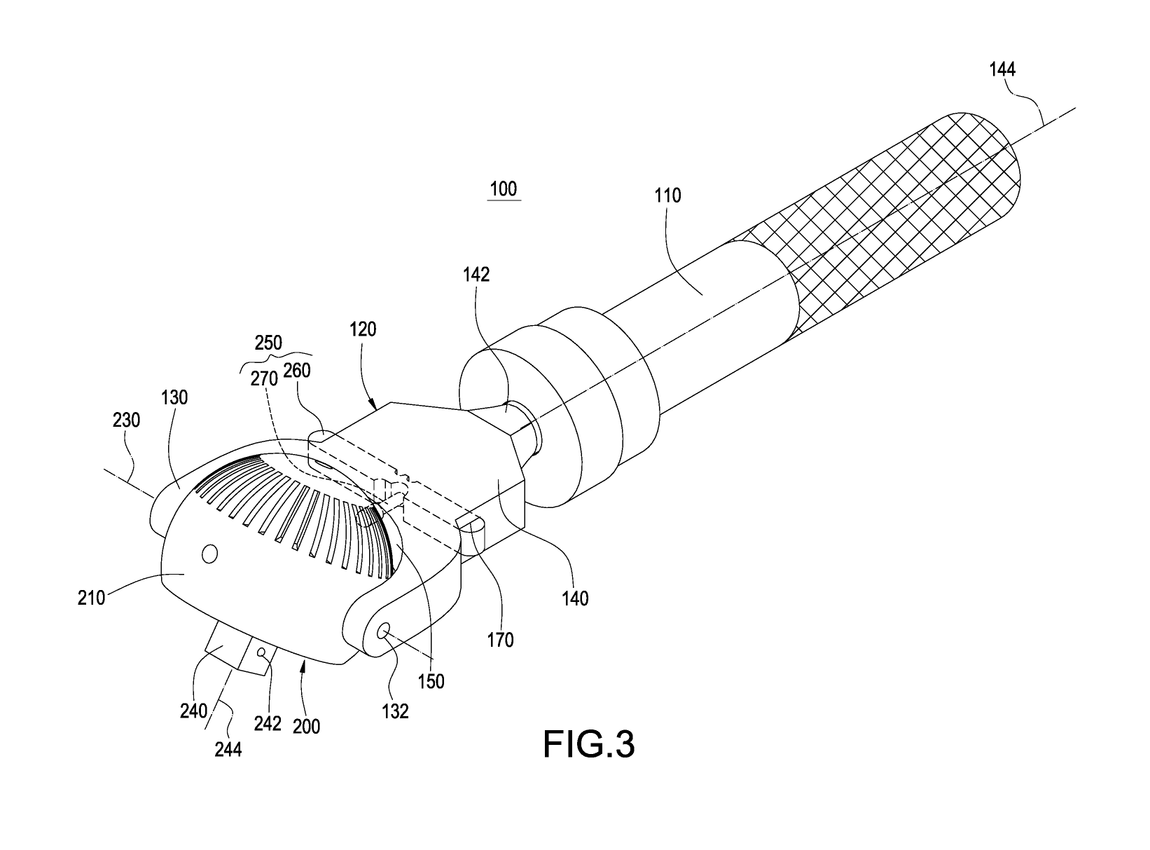

Referring to FIGS. 1 to 4, the present invention relates to a ratchet wrench 100 with a positioning structure. The ratchet wrench 100 comprises a drive bar 120, a rotary head 200 and a locking button 250. In the present embodiment, the ratchet wrench 100 preferably includes an operation handle 110 which receives the drive bar 120. By quickly rotating the operation handle 110 when the ratchet wrench 100 is in an upright state or by moving back and forth the operation handle 110 when the ratchet wrench 100 is in a horizontal state, the rotary head 200 tightens or loosens an object (not illustrated).

The drive bar 120 includes a fork arm 130, a fork opening 150 formed at the fork arm 130, an axial hole 160 communicating with the fork opening 150, and a radial hole 170 communicating with the axial hole 160. As shown in the drawing, the fork arm 130 includes two forks (not labelled), and the fork opening 150 is formed between two forks. The rotary head 200 is pivotally connected to two ends of the fork arm 130. The rotary head 200 includes a round housing 210 and a ratchet apparatus (not illustrated) disposed in the round housing 210, a plurality of positioning recesses 220 disposed on the round housing 210, and a pivot axis 230 located at the rotary head 200 and passing through the two ends of the fork arm 130, wherein the pivot axis 230 is parallel to the radial hole 170.

The rotary head 200 further includes an output element 240 in a rectangular shape protruding from one end of the round housing 210, a positioning ball 242 at one side surface of the output element 240, and a ratchet apparatus (not illustrated) connected to the rectangular output element 240. Moreover, the ratchet apparatus is disposed inside the round housing 210, and a variety of sleeves (not illustrated) in different sizes can be engagedly assembled by means of the positioning ball 242 of the output element 240, so that the object can be tightened or loosened. The ratchet apparatus is a conventional apparatus, so a detailed description thereof is omitted for brevity.

In the present embodiment, the drive bar 120 further includes two supporting bolts 132, an enlarged end 140 and a bar body 142. The supporting bolts 132 are inserted through two ends of the fork arm 130 respectively and are fixed between the round housing 210 and the fork arm 130. The pivot axis 230 is an imaginary line passing through an axle center of each supporting bolt 132, so that the rotary head 200 is freely rotatable about the pivot axis 230 at the fork opening 150 to certain angles, e.g. from 0 to 270 degrees. The enlarged end 140 is disposed between the fork arm 130 and the bar body 142. A size of the enlarged end 140 is greater than a size of the bar body 142. The axial hole 160 and the radial hole 170 are preferably disposed in the enlarged end 140. In other words, the locking button 250 is also disposed in the enlarged end 140, and therefore the ratchet wrench 100 of the present embodiment has better strength and provides superior operation quality.

Furthermore, the positioning recesses 220 at least includes a first positioning recess 222 disposed on a top of the round housing 210 and a second positioning recess 224 disposed at each of two opposite sides of the round housing 210. The first positioning recess 222 and the second positioning recess 224 form an included angle of 90 degrees therebetween, so that a user can operate the ratchet wrench 100 in an upright state, i.e. a central axis 244 of the output element 240 is parallel to a rotation axis 144 of the drive bar 120, or alternatively in a horizontal state, i.e. the central axis 244 of the output element 240 is perpendicular to the rotation axis 144 of the drive bar 120. The rotation axis 144 is preferably a central line of the drive bar 120 and/or the operation handle 110. The positioning recess 220 is preferably in a shape corresponding to the shape of the latch bar 270, so as to facilitate engagement of the latch bar 270 with the positioning recess 220.

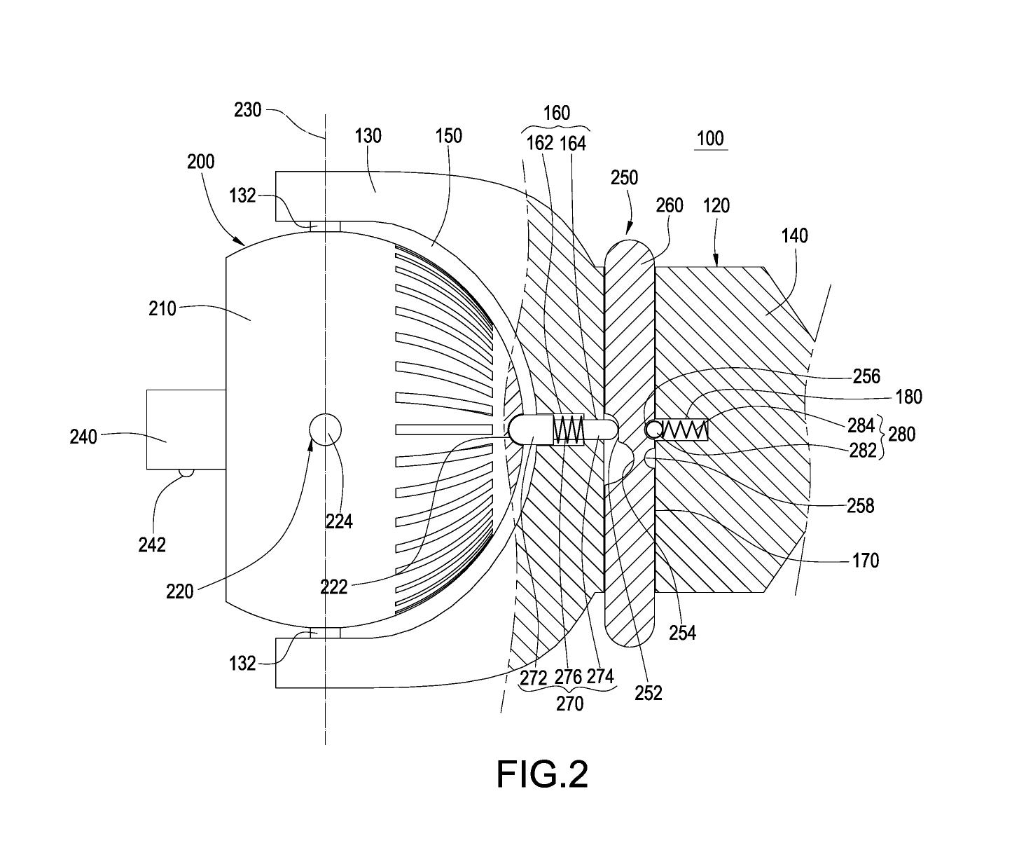

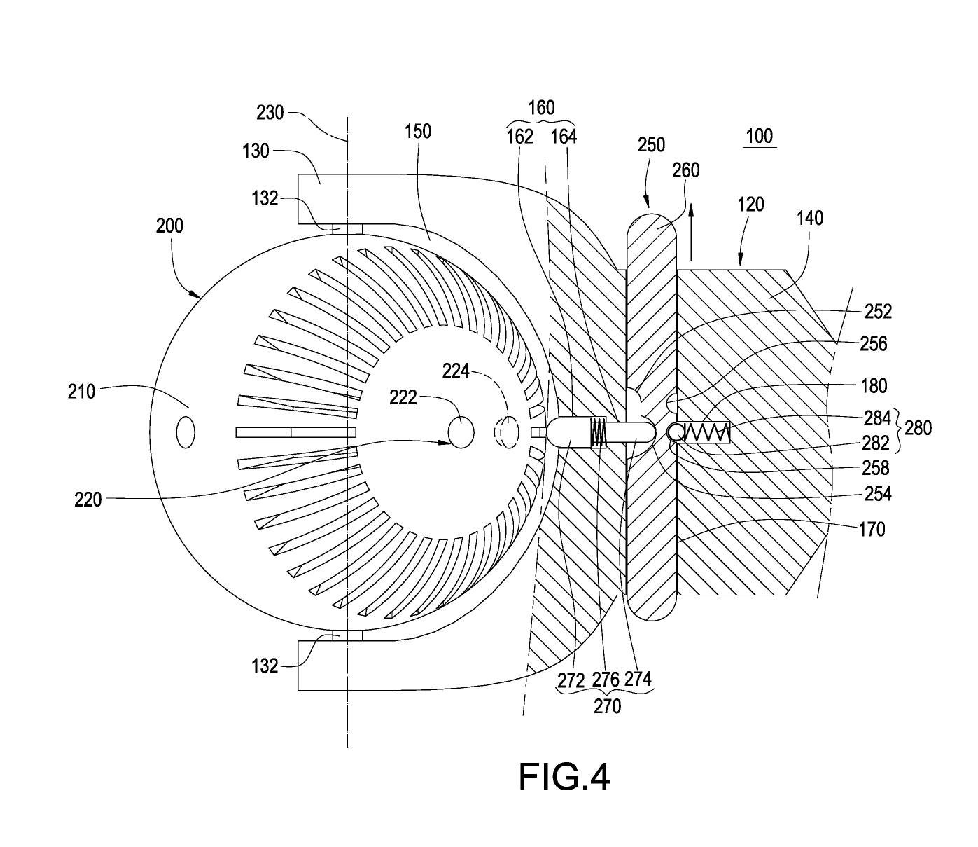

The locking button 250 includes a locking rod 260 disposed in the radial hole 170 and a latch bar 270 disposed in the axial hole 160. It is preferable that two ends of the locking rod 260 protrude out of two openings of the radial hole 170, so as to facilitate the user's pressing or moving back and forth the locking rod 260. The locking rod 260 transversely moves from a release position (see FIG. 4) to a locked position (see FIG. 2), so that the latch bar 270 is driven to move to protrude into the fork opening 150 and be engaged with any of the positioning recesses 220.

In the embodiment shown in FIGS. 2, 4 and 6, one side of the locking rod 260 corresponding to the axial hole 160 includes a locking recess 252 and a release recess 254 adjacent to the locking recess 252, and the other side of the locking rod 260 includes a first indentation 256 and a second indentation 258. When the locking rod 260 transversely moves in the radial hole 170, the latch bar 270 is driven to move axially in the axial hole 160. In other words, when the locking rod 260 moves, one end of the latch bar 270 is slidable to contact the locking recess 252 or the release recess 254, and the other end of the latch bar 270 is engaged with or released from any of the positioning recesses 220 of the rotary head 200, wherein a depth/size of the locking recess 252 is less than a depth/size of the release recess 254.

In the present embodiment, the latch bar 270 includes a first bar 272, a second bar 274 connected to the first bar 272, and a compression spring 276 connected to the first bar 272 or the second bar 274. The axial hole 160 of the drive bar 120 includes a first hole 162 and a second hole 164 communicating with the first hole 162. The first bar 272 is received in the first hole 162, and the second bar 274 is received in the second hole 164, wherein the first bar 272 has a greater diameter than a diameter of the second bar 274, so that the compression spring 276 can receive the second bar 274. Moreover, an end portion of the first bar 272 is in a shape corresponding to the shape of each positioning recess 220, e.g. having an arc shape or other suitable shape, so as to be engaged with each positioning recess 220 correspondingly.

In the present embodiment, two ends of the compression spring 276 are preferably connected to the first bar 272 and a bottom end of the first hole 162, so as to exert a spring force to force the latch bar 270 to protrude outward in a direction toward the fork opening 150. When the locking rod 260 of the locking button 250 transversely moves from the release recess 254 to the locking recess 252, the latch bar 270 is forced by the compression spring to protrude outwardly of the axial hole 160 to be engaged with any of the positioning recesses 222, 224. On the contrary, when the locking rod 260 transversely moves from the locking recess 252 to the release recess 254, the compression spring 276 recoils to pull back the latch bar 270. At this point, one end of the latch bar 270 is disengaged from the rotary head 200, and the other end of the latch bar 270 is in contact with the release recess 254. Accordingly, the user only needs to moves the locking rod 260 back and forth along a direction of the pivot axis 230 to fasten or release the rotary head 200 quickly.

In order to enhance the stability and reliability of the locking button 250 in the locked position or the released position, the present embodiment further includes a retaining structure 280. The retaining structure 280 is disposed in a retaining recess 180 of the drive bar 120. The retaining recess 180 is preferably on the same line (not illustrated) as the axial hole 160, so as to provide a stronger retaining force. The retaining structure 280 includes a retaining element 282 and a retaining spring 284 connected to the retaining element 282, wherein the first indentation 256 and the second indentation 258 are disposed corresponding to the retaining recess 180.

According to the embodiment shown in FIGS. 2, 4 and 6, the first indentation 256 is preferably disposed corresponding to the locking recess 252, and the second indentation 258 is preferably disposed corresponding to the release recess 254, so that the locking button 250 can be retained in the lock position or the released position. The retaining element 282 is preferably a spherical rolling ball, an arc-shaped rolling ball, or the likes. The retaining spring 284 is a compression spring, so as to flexibly fasten the locking rod 260 in the first indentation 256 or the second indentation 258.

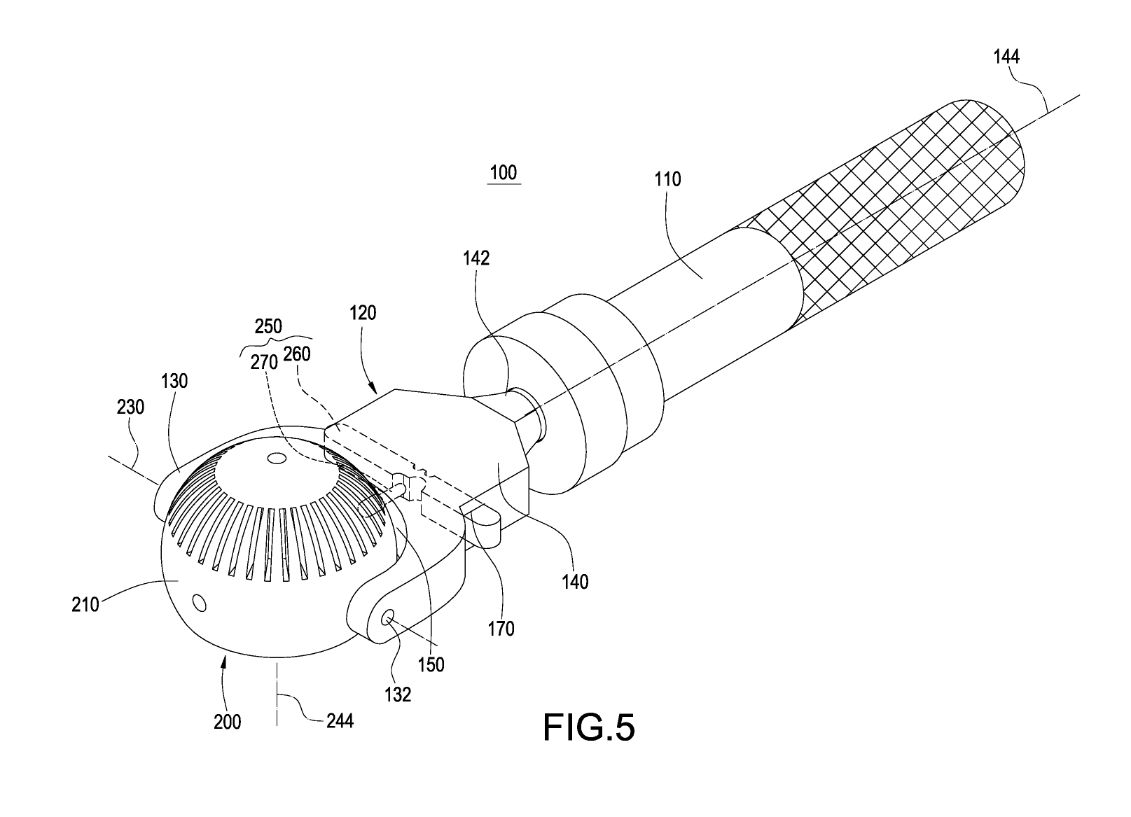

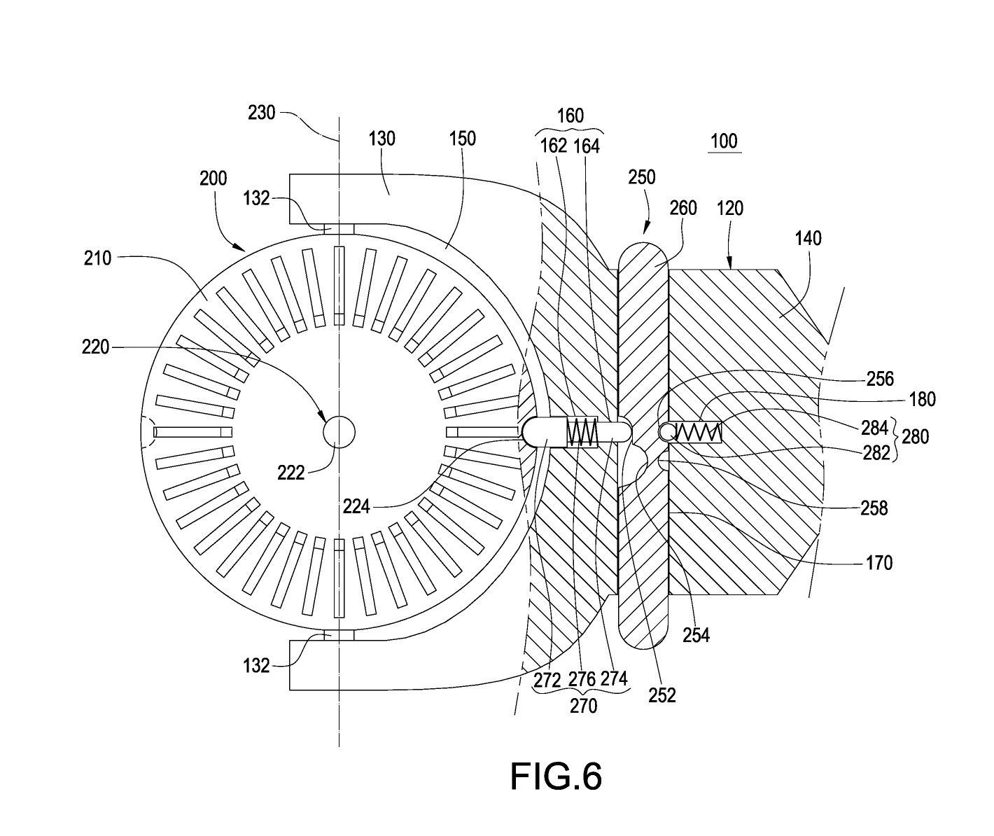

Please refer to FIGS. 5 and 6 which are still another perspective view and a partial cross-sectional view illustrating the ratchet wrench with the positioning structure according to the present invention, wherein a center of the output element of the rotary head 200 is perpendicular to the axis of the drive bar 120. When in some work environments the user has to adjust the central axis 244 of the rotary head 200 to be perpendicular to the rotation axis 144 of the drive bar 120, the user transversely pushes the locking rod 260 of the locking button 250, and at the same time the latch bar 270 moves from the locking recess 252 to the release recess 254.

At this point, the rotary head 200 is free to rotate to a position wherein the central axis 244 of the output element 240 is perpendicular to the rotation axis 144 of the drive bar 120, so that the second positioning recess 224 is aligned with the axial hole 160. Then, the user pushes in an opposite direction the locking rod 260 of the locking button 250, so at the same time the latch bar 270 moves from the release recess 254 to the locking recess 252, and thereby the latch bar 270 is engaged with the second positioning recess 224. Therefore, an object can be tightened or loosened when the wrench is operated horizontally.

It is to be understood that the above descriptions are merely the preferable embodiment of the present invention and are not intended to limit the scope of the present invention. Equivalent changes and modifications made in the spirit of the present invention are regarded as falling within the scope of the present invention.

What is claimed is:

1. A ratchet wrench with a positioning structure, comprising:
a drive bar, the drive bar including a fork arm, a fork opening formed at the fork arm, an axial hole communicating with the fork opening, and a radial hole communicating with the axial hole;
a rotary head pivotally connected to two ends of the fork arm, the rotary head including a round housing, a ratchet apparatus disposed inside the round housing, a plurality of positioning recesses disposed on the round housing, and a pivot axis located at the rotary head and passing through the two ends of the fork arm, wherein the pivot axis is parallel to the radial hole; and
a locking button, the locking button including a locking rod disposed in the radial hole and a latch bar disposed in the axial hole, the locking rod being transversely movable in association with movement of the latch bar, the latch bar being engaged with or disengaged from any of the positioning recesses.

2. The ratchet wrench with the positioning structure of claim 1, wherein one side of the locking rod corresponding to the axial hole includes a locking recess and a release recess adjacent to the locking recess, and the other side of the locking rod includes a first indentation and a second indentation.

3. The ratchet wrench with the positioning structure of claim 2, wherein one end of the latch bar is slidable to contact the locking recess or the release recess.

4. The ratchet wrench with the positioning structure of claim 2, wherein a depth/size of the locking recess is less than a depth/size of the release recess.

5. The ratchet wrench with the positioning structure of claim 2, wherein the latch bar includes a first bar, a second bar connected to the first bar, and a compression spring connected to the first bar or the second bar, and the axial hole includes a first hole and a second hole communicating with the first hole.

6. The ratchet wrench with the positioning structure of claim 5, wherein the first bar is received in the first hole, the second bar is received in the second hole, and the first bar has a greater diameter than a diameter of the second bar.

7. The ratchet wrench with the positioning structure of claim 2, wherein the locking button includes a retaining structure, the drive bar forms a retaining recess, and the retaining structure is disposed in the retaining recess.

8. The ratchet wrench with the positioning structure of claim 7, wherein the retaining structure includes a retaining element and a retaining spring connected to the retaining element.

9. The ratchet wrench with the positioning structure of claim 7, wherein the first indentation and the second indentation are disposed corresponding to the retaining recess.

10. The ratchet wrench with the positioning structure of claim 8, wherein the retaining element is a spherical rolling ball or an arc-shaped rolling ball, the retaining spring is a compression spring.

11. The ratchet wrench with the positioning structure of claim 1, wherein the drive bar further includes an enlarged end and a bar body, the enlarged end is disposed between the fork arm and the bar body, and the axial hole and the radial hole are disposed in the enlarged end.

12. The ratchet wrench with the positioning structure of claim 1, wherein each of the positioning recesses at least includes a first positioning recess disposed on a top of the round housing and a second positioning recess disposed at each of two opposite sides of the round housing.

13. The ratchet wrench with the positioning structure of claim 11, wherein the first positioning recess and the second positioning recess form an included angle of 90 degrees therebetween.
